(19) United States
(12) Patent Application Publication
(10) Pub. No.: US 2008/0291802 A1
(43) Pub. Date: Nov. 27, 2008

(54) OPTICAL DISC TYPE DETERMINING APPARATUS AND METHOD THEREOF

(76) Inventor: Yao-Lung Chuang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/751,045

(22) Filed: May 21, 2007

(51) Int. Cl. G11B 7/00

(52) U.S. Cl. 369/53.22

(57) ABSTRACT

The present invention disclosed an optical disc drive determining apparatus. The optical disc drive determining apparatus includes an optical pick-up head, a signal processing module, and a discriminator. The optical pick-up head is for receiving a reflected signal from an optical disc. The signal processing module, coupled to the optical pick-up head, is for processing the reflected signal into a derived signal having a plurality of pulses. The discriminator, coupled to the signal processing module, is for analyzing widths of the pulses to determine a disc type of the optical disc.

### BACKGROUND

The present invention relates to an optical disc drive, and more particularly, to an optical disc drive determining apparatus for identifying a loaded optical disc as a DVD-RAM disc by using statistical analysis and method thereof.

The process of identifying a disc type loaded into an optical disc drive is getting more complicated nowadays. This is because that various types of optical discs that have been developed, such as CD (Compact Disc) and DVD (Digital Versatile Disc), and many others are increasing in number. Furthermore, the specifications of the DVD can be divided into DVD-ROM, DVD-ROM dual layer, DVD-R, DVD-R dual layer, DVD-RW, DVD+R, DVD+R dual layer, DVD+RW, DVD-RAM, and so on. In addition, the data format of one DVD type is dramatically difference with that of other types, for example, data of DVD-RAM disc is not only stored in the land but also the groove of DVD-RAM disc, and the data density also varies according to the radius of DVD-RAM disc. Therefore, an appropriate in time identifying process should be executed after an optical disc is loaded into the optical disc drive in order to identify the disc type of the inserted optical disc.

A DVD-RAM disc is capable of recording and deleting data freely. Such a DVD-RAM disc has a recording capacity capable of recording massive amounts of data. The DVD-RAM disc comprises data sectors for use in recording data. Each data sector largely includes a header region and a recording region, where the header region includes identification data containing a sector number and sector information, and the recording region is called a user region used for storing user data. The related art of identifying the DVD-RAM disc is processed by calculating the number of header regions of the optical disc loaded into the optical disc drive. Normally, the related art optical disc drive emits laser light to the inserted optical disc through an optical pick-up unit and then receives a corresponding reflected signal to calculate the number of header regions of the optical disc because the reflected signal from the header region will be a high level signal. However, when an empty DVD±RW disc (i.e., no data has yet been recorded on the DVD±RW disc) is loaded into the optical disc drive, the related art identifying process will probably misjudge the empty DVD±RW disc as a DVD-RAM disc. This is because that noise signal reflected from the empty DVD±RW disc may very well be judged as being a signal reflected from header region of a DVD-RAM disc.

In another related art for identifying DVD-RAM discs, a process is executed for calculating the distance between header regions of the optical disc loaded into the optical disc drive. The distance between header regions is derived from the time interval between two high-level pulses of the reflected signal sensed by the optical pick-up unit. Similarly, the noise interference might affect the distance between header regions, degrading the disc type identification accuracy.

Therefore, an improved and novel disc type determining scheme is needed.

### SUMMARY

It is therefore an objective of the claimed invention to provide a disc drive determining apparatus and method thereof for identifying a loaded optical disc as a DVD-RAM disc by using statistical analysis.

Briefly described, an embodiment of a disc type determining apparatus comprises an optical pick-up head, a signal processing module, and a discriminator. In which, the optical pick-up head is for receiving a reflected signal from an optical disc; the signal processing module, coupled to the optical pick-up head, is for processing the reflected signal into a derived signal having a plurality of pulses; and the discriminator, coupled to the signal processing module, is for analyzing widths the pulses to determine a disc type of the optical disc.

In addition, a method for determining a disc type is disclosed. The method includes: receiving a reflected signal from an optical disc; processing the reflected signal into a derived signal having a plurality of pulses; and analyzing widths the pulses to determine a disc type of the optical disc.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a disc type determining apparatus according to an embodiment of the present invention.

FIG. 2 is a waveform diagram illustrating a derived signal, an output signal, and an indication signal if an optical disc shown in FIG. 1 is a DVD-RAM disc.

FIG. 3 is a diagram illustrating a distribution of pulse widths of the indication signal.

FIG. 4 is a flowchart of a method for determining a disc type of the optical disc shown in FIG. 1 according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

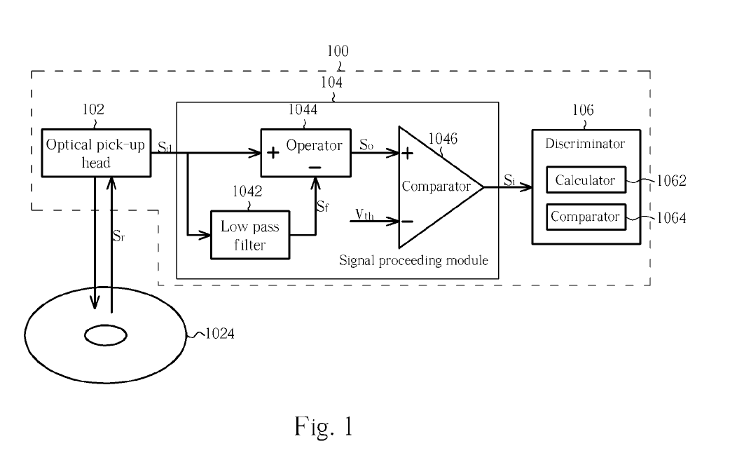

Please refer to FIG. 1. FIG. 1 illustrates a diagram of a disc type determining apparatus 100 according to an embodiment of the present invention. The disc type determining apparatus 100 is able to determine if a disc type of an optical disc 1024 is DVD-RAM. The disc type determining apparatus 100 is implemented in an optical disc drive, and comprises an optical pick-up head 102, a signal processing module 104, and a discriminator 106. In which, the optical pick-up head 102 is for receiving a reflected signal Sᵣ from the optical disc 1024; the signal processing module 104, coupled to optical pick-up head 102, is for processing the reflected signal Sᵣ into an indication signal Sᵢ having a plurality of pulses; and a discriminator 106, coupled to the signal processing module 104, is for analyzing the widths of the pulses to determine a disc type of the optical disc 1024 loaded into the optical disc drive.

As shown in FIG. 1, the signal processing module 104 comprises a low pass filter 1042, an operator 1044, and a comparator 1046. In which, the low pass filter 1042 is for filtering a derived signal S_{d} to generate a filtered signal S_{f}, where the derived signal S_{d} is derived from the reflected signal Sᵣ by the optical pick-up head 102; the operator 1044, coupled to low pass filter 1042, is for subtracting the filtered signal S_{f} from the derived signal S_{d} to generate an output signal Sₒ; and the comparator 1046, coupled to the operator 1044 and a threshold voltage Vₜₕ, is for comparing the output signal Sₒ with the threshold voltage Vₜₕ to generate the indication signal Sᵢ, wherein when the output signal Sₒ is greater than the threshold voltage Vₜₕ, the comparator 1044 outputs a pulse. In other words, for the indication signal Sᵢ a pulse is triggered each time the output signal Sₒ is greater than the threshold voltage Vₜₕ. Please note that the derived signal S_{d} could be a DPP (differential push-pull) signal, RF level signal, FE (focus error signal), or DPD (differential phase detection) signal, and any circuit architectures capable of referencing the derived signal S_{d} to generate the indication signal Sᵢ containing pulses corresponding to DVD-RAM headers can be adopted by the disc type determining apparatus 100.

Moreover, as shown in FIG. 1, the discriminator 106 comprises a calculator 1062 and a comparator 1064. In which, the calculator 1062 is for calculating a mean value of the widths of the pulses carried via the indication signal Sᵢ; and the comparator 1064, coupled to the calculator, for comparing the mean value with a specific threshold range T_{del} to determine the disc type of the loaded optical disc 1024. The operation of identifying the disc type is detailed as below.

Whenever the optical disc 1024 is loaded into the optical disc drive, the optical pick-up head 102 is actuated to emit a laser signal upon a specific track on a data recording layer of the optical disc 1024. Meanwhile, a reflected signals Sᵣ is generated, and the optical pick-up head 102 receives the reflected signals Sᵣ reflected from the specific track of the optical disc 1024. The specific track of the optical disc 1024 is supposed to be a track that contains a plurality of headers specified by DVD-RAM specification, where the positions of these headers are also well defined. Whenever the laser signal is injected into a DVD-RAM header, the reflected signal corresponding to the DVD-RAM header location has a rather high signal level. If the optical disc 1024 is a DVD-RAM disc, then the reflected signal Sᵣ will have a series of high signal levels in response to DVD-RAM headers; however, if the optical disc 1024 is not a DVD-RAM disc, then the reflected signal Sᵣ will contain noise or other pulse distributions different from that of the DVD-RAM disc.

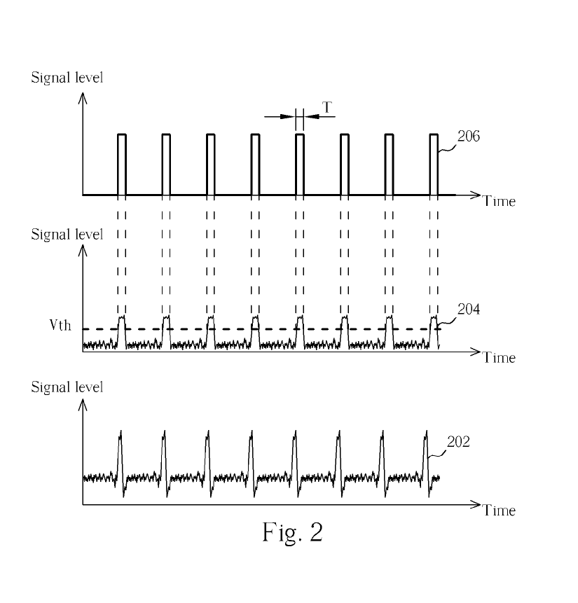

Please refer to FIG. 2 in conjunction with FIG. 1. FIG. 2 illustrates a waveform diagram of the derived signal S_{d}, the output signal Sₒ, and the indication signal Sᵢ if the optical disc 1024 shown in FIG. 1 is a DVD-RAM disc. Accordingly, the optical pick-up head 102 generates the derived signal S_{d} from processing the reflected signals Sᵣ and then transmits the derived signal S_{d} to the signal processing module 104 for further following signal processing. The waveform 202 shown in FIG. 2 illustrates the derived signal S_{d} if the optical disc 1024 is a DVD-RAM disc. The derived signal S_{d} is transmitted separately into two paths, where the first path directly transmits the derived signal S_{d} into a first input N₁ of operator 1044, and the second path comprises the low pass filter 1042 to perform a low-pass filtering upon the derived signal S_{d} to generate a filtered signal S_{f}. In this embodiment, the operator 1044 comprises a subtracting circuit to subtract the filtered signal S_{f} from the derived signal S_{d}. As known to those skilled in this art, the derived signal S_{d} comprises a series of pulses level-shifted by a DC level, where the DC level has no contribution to disc type determination and might affect the disc type determination if the derived signal S_{d} is greatly biased by the DC level. Therefore, the disc type determining apparatus 100 utilizes the low pass filter 1042 to filter out the pulses carried via the derived signal S_{d} in the second path and the filtered signal S_{f} is just left with the DC level; the operator 1044 then subtracts the filtered signal S_{f} (i.e., the DC level of the derived signal S_{d}) from the derived signal S_{d} to generate the DC-free output signal Sₒ. Accordingly, no DC level is present or remaining in the output signal Sₒ but just the pulses of the derived signal S_{d}. The waveform 204 shown in FIG. 2 illustrates the output signal Sₒ if the optical disc 1024 is a DVD-RAM disc.

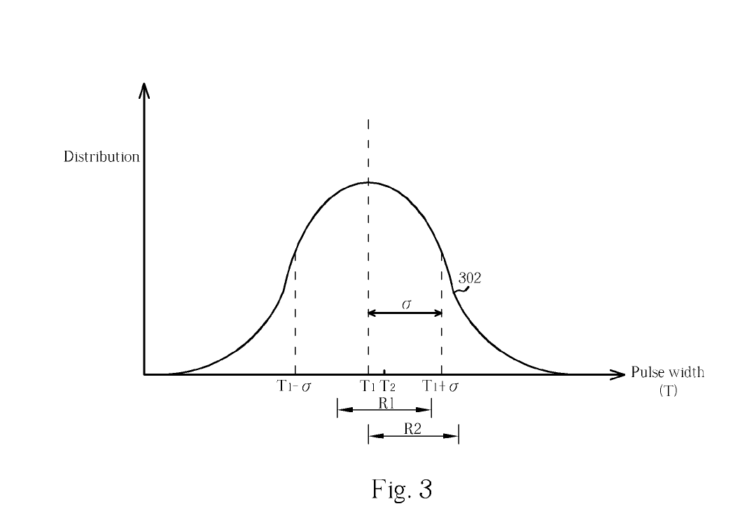

The output signal Sₒ is then transmitted to the comparator 1046 to generate the indication signal Sᵢ. According to the present invention, the comparator 1046 is utilized for differentiating the signal level of the output signal Sₒ with the threshold voltage Vₜₕ, wherein the threshold voltage Vₜₕ is tuned to a magnitude that is capable of differentiating the pulses reflected in response to DVD-RAM headers. Therefore, the indication signal Sᵢ will either be at a high level or a low level; if the optical disc 1024 is a DVD-RAM disc, then the indication signal Sᵢ will have pulses each with a pulse width falling in a specific range. Ideally, the pulse widths of the pulses are identical to each other, and match the length of a DVD-RAM header. The waveform 206 shown in FIG. 2 illustrates the indication signal Sᵢ if the optical disc 1024 is a DVD-RAM disc. To analyze the pulse width T of each pulse in the indication signal Sᵢ, the indication signal Sᵢ is further transmitted to the discriminator 106, where the discriminator 106 runs a statistical analysis for the indication signal Sᵢ. In this embodiment, the discriminator 106 first utilizes the calculator 1062 to measure and record each pulse width of the indication signal Sᵢ, and then calculates a mean value of the recorded pulse widths of the indication signal Sᵢ. Please refer to FIG. 3. FIG. 3 is a diagram illustrating a distribution curve 302 of pulse widths of the indication signal Sᵢ, where the mean value T₁ represents an average of the pulse widths of the indication signal Sᵢ. If the optical disc 1024 is a DVD-RAM disc, then the calculated mean value T₁ will be close to an ideal pulse width T₂ corresponding to a DVD-RAM header. Therefore, the comparator 1064 compares the calculated mean value T₁ and the ideal pulse width T₂ to check whether the loaded optical disc 1024 is a DVD-RAM disc. As shown in FIG. 3, the mean value T₁ falls in a first specific threshold range R₁, and the comparator 1064 deems that the mean value T₁ is close to the ideal pulse width T₂, and in one embodiment the discriminator 106 identifies that the loaded optical disc 1024 is a DVD-RAM disc. However, in order to improve the disc type identifying accuracy, more parameters can be referenced. For example, checking a standard deviation value σ provides a protection mechanism for the disc type identification. In another embodiment, the calculator 1062 further calculates the standard deviation value σ of the recorded pulse widths, and the comparator 1064 further compares the standard deviation value σ with a second specific threshold range R₂ to determine the disc type of the optical disc 1024. As one can see, when the standard deviation value σ falls in the second specific threshold range R₂, it represents that most of the recorded pulse widths are close to the mean value T₁ and are not induced by noise. Therefore, when both the mean value T₁ falls in the first specific threshold range R₁ and the standard deviation value σ falls in the second specific threshold range R₂, there is a high probability that the loaded optical disc 1024 is a DVD-RAM disc. In this case, the discriminator 106 uses the comparison result of the standard deviation value σ and the second specific threshold range R₂ to further confirm the disc type identification result.

Please note that, the discriminator 106 of the embodiment is not limited to the above-mentioned statistical analysis. For example, in other embodiments, the discriminator 106 first utilizes the calculator 1062 to accumulate the pulse widths of indication signal Sᵢ to generate a sum value. If the optical disc 1024 is a DVD-RAM disc, then the sum value will close to an ideal sum value of ideal pulse widths corresponding to DVD-RAM headers. Accordingly, the comparator 1064 compares the calculated sum value and the ideal sum value to determine the disc type. Similarly, when the calculated sum value falls in a specific threshold range, the discriminator 106 deems that the loaded optical disc 1024 is a DVD-RAM disc. It should be noted that no averaging operation is performed when referencing the sum value to identify the disc type of the optical disc 1024.

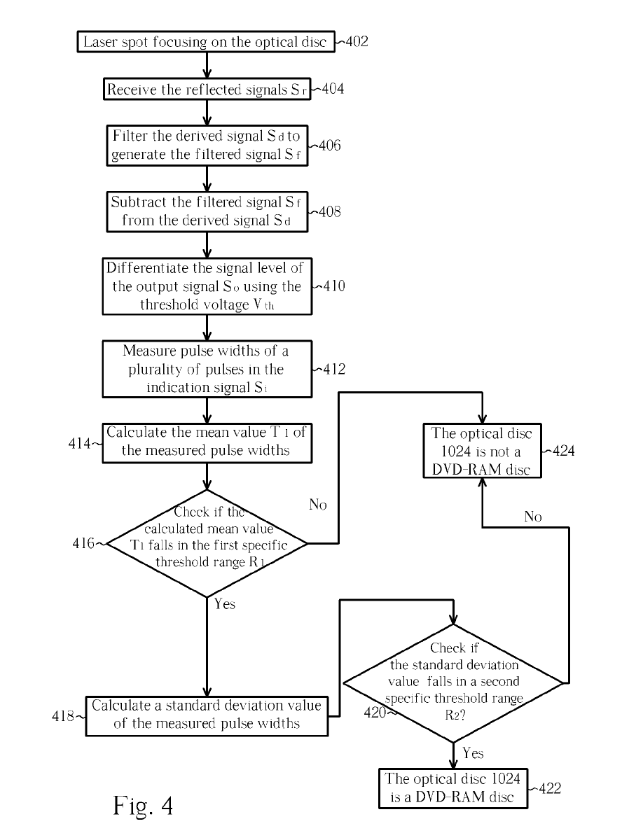

Please refer to FIG. 4. FIG. 4 illustrates a flowchart of a method for determining a disc type of the optical disc 1024 shown in FIG. 1 according to an embodiment of the present invention. The first method is performed by the disc type determining apparatus 100 and summarized as below:
Step 402: Laser spot focusing on the optical disc 1024;
Step 404: Receive the reflected signals Sᵣ from a specific track of the optical disc 1024;
Step 406: Filter the derived signal S_{d} to generate the filtered signal S_{f};
Step 408: Subtract the filtered signal S_{f} from the derived signal S_{d} to generate the output signal Sₒ;
Step 410: Differentiate the signal level of the output signal Sₒ using the threshold voltage Vₜₕ to generate the indication signal Sᵢ;
Step 412: Measure pulse widths of a plurality of pulses in the indication signal Sᵢ;
Step 414: Calculate the mean value T₁ of the measured pulse widths;
Step 416: Check to determine if the calculated mean value T₁ falls in the first specific threshold range R₁. If yes, go to step 418; otherwise, go to step 424;
Step 418: Calculate a standard deviation value σ of the measured pulse widths;
Step 20: Check to determine if the standard deviation value σ falls in a second specific threshold range R₂. If yes, go to step 422; otherwise, go to step 424;
Step 422: Determine that the optical disc 1024 is a DVD-RAM disc.
Step 424: Determine that the optical disc 1024 is not a DVD-RAM disc.

In Step 416 and 422, if the mean value T₁ falls in a first specific threshold range R₁, and the comparator 1064 deems that the mean value T₁ is close to the ideal pulse width T₂, then the discriminator 106 identifies that the loaded optical disc 1024 is a DVD-RAM disc. Furthermore, in order to improve the disc type identifying accuracy, more parameters can be referenced. For example, checking a standard deviation value σ provides a protection mechanism for the disc type identification. In other words, the calculator 1062 can further calculate the standard deviation value σ of the recorded pulse widths, and the comparator 1064 further compares the standard deviation value σ with a second specific threshold range R₂ to determine the disc type of the optical disc 1024. Then, when the standard deviation value σ falls in the second specific threshold range R₂, it represents that most of the recorded pulse widths are close to the mean value T₁ and are not induced by noise. Therefore, when both the mean value T₁ falls in the first specific threshold range R₁ and the standard deviation value σ falls in the second specific threshold range R₂, there is a high probability that the loaded optical disc 1024 is a DVD-RAM disc. Please note that, in steps 406 through 408, the derived signal S_{d} could be a DPP (differential push-pull) signal, RF level signal, FE (focus error signal), or DPD (differential phase detection) signal, and any circuit architectures capable of referencing the derived signal S_{d} to generate the indication signal Sᵢ containing pulses corresponding to DVD-RAM headers can be adopted by the disc type determining apparatus 100. In order to improve the disc type identifying accuracy, in steps 418 through 420, checking a standard deviation value σ provides a protection mechanism for the disc type identification. With proper modifications to the flow shown in FIG. 4, persons skilled in this art can easily derive flow of identifying the disc type using the sum value instead of mean value. Therefore, further description is omitted for the sake of brevity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A disc type determining apparatus, comprising:
an optical pick-up head, for receiving a reflected signal from an optical disc;
a signal processing module, coupled to the optical pick-up head, for processing the reflected signal into a derived signal having a plurality of pulses; and
a discriminator, coupled to the signal processing module, for analyzing widths of the pulses to determine a disc type of the optical disc.

2. The apparatus of claim 1, wherein the signal processing module comprises:
a low pass filter, for filtering the derived signal to generate a filtered signal, wherein the derived signal is derived from the reflected signal;
an operator, coupled to the low pass filter, for subtracting the filtered signal from the derived signal to generate an output signal; and
a comparator, coupled to the operator and a threshold voltage, for comparing the output signal with the threshold voltage to generate an indication signal, wherein when the output signal is greater than the threshold voltage, the comparator outputs a pulse.

3. The apparatus of claim 2, wherein the discriminator analyzing widths of a plurality of pulses of the indication signal to determine the disc type of the optical disc.

4. The apparatus of claim 3, wherein the indication signal is an IDGATE signal for indicating a header area of the optical disc.

5. The apparatus of claim 1, wherein the derived signal is selected from the group consisted of a RF signal, a TE signal.

6. The apparatus of claim 1, wherein the discriminator comprises:
a calculator, for calculating a mean value of the widths of the pulses; and
a comparator, coupled to the calculator, for at least comparing the mean value with a first specific threshold range to determine the disc type of the optical disc.

7. The apparatus of claim 6, wherein the calculator further calculates a standard deviation value of the widths of the pulses; and the comparator further compares the standard deviation value with a second specific threshold range to determine the disc type of the optical disc.

8. The apparatus of claim 1, wherein the discriminator comprises:
a calculator, for accumulating the widths of the pulses to determine a sum value; and
a comparator, coupled to the calculator, for comparing the sum value with a specific threshold range to determine the disc type of the optical disc.

9. The apparatus of claim 1, wherein the discriminator is utilized to determine if the disc type of the optical disc is DVD-RAM.

10. A method for determining a disc type, comprising:
receiving a reflected signal from an optical disc;
processing the reflected signal into a derived signal having a plurality of pulses; and
analyzing widths of the pulses to determine a disc type of the optical disc.

11. The method of claim 10, wherein the step of processing the reflected signal comprises:
performing a low pass filtering on the derived signal to generate a filtered signal;
subtracting the filtered signal from the derived signal to generate an output signal; and
comparing the output signal with a threshold voltage to generate an indication signal, wherein when the output signal is greater than the threshold voltage, a pulse is generated.

12. The method of claim 11, wherein the step of analyzing is to analyze widths of a plurality of pulses of the indication signal to determine the disc type of the optical disc.

13. The method of claim 12, wherein the indication signal is an IDGATE signal for indicating a header area of the optical disc.

14. The method of claim 10, wherein the derived signal is selected from the group consisted of a RF signal and a TE signal.

15. The method of claim 10, wherein the step of determining the disc type of the optical disc comprises:
calculating a mean value of the widths of the pulses; and
comparing the mean value with a first specific threshold range to determine the disc type of the optical disc.

16. The method of claim 15, wherein the step of determining the disc type of the optical disc further comprises: calculating a standard deviation value of the widths of the pulses; and the step of comparing the mean value with the first specific threshold range to determine the disc type of the optical disc further compares the standard deviation value with a second specific threshold range to determine the disc type of the optical disc.

17. The method of claim 10, wherein the step of determining the disc type of the optical disc comprises:
accumulating the widths of the pulses to determine a sum value; and
comparing the sum value with a specific threshold range to determine the disc type of the optical disc.

18. The method of claim 10, wherein the step of determining the disc type of the optical disc determines if the disc type of the optical disc is DVD-RAM.
